(19) United States
(12) Patent Application Publication
(10) Pub. No.: US 2011/0067256 A1
(43) Pub. Date: Mar. 24, 2011

(54) Position display device providing digital displacement signal

(75) Inventor: Shie-Li Jan, Taichung City (TW)

(73) Assignee: Hiwin Mikrosystem Corp.

(21) Appl. No.: 12/586,259

(22) Filed: Sep. 18, 2009

(51) Int. Cl. G01B 7/00

(52) U.S. Cl. 33/708; 324/207.11

(57) ABSTRACT

A position display device providing a digital displacement signal is disclosed. The position display device includes an analogical signal input port electrically connected to a position probe of a magnetic scale, a position display module, a display unit, an analog/digital conversion module, and a digital signal output port. The position display device converts the received analogical displacement signal into a readout visually readable to an operator and displaying the readout through a display unit. The position display device also converts the analogical displacement signal into the digital displacement signal and outputs the digital displacement signal for an external motor controller to use.

### BACKGROUND OF THE INVENTION

1. Technical Field

The present invention relates to position display devices of linear motors, and more particularly, to a position display device that provides a digital displacement signal.

2. Description of Related Art

As shown in FIG. 1, a conventional linear motor 1, for accurate control of travel and position, is provided with a magnetic scale 2 that has a position probe 3 installed on a mover of the linear motor 1. The position probe 3 serves to detect the magnetic variation of the magnetic scale 2 and outputs a position detecting signal to a motor controller 4, a PLC, a control computer or the like, for giving feedback about the actual operational position of the linear motor 1.

Referring to FIG. 2, the signal generated by the position probe 3 is usually an analogical signal that has to be converted into a digital signal by a signal converter 5 for the motor controller 4, the PLC, the control computer or the like to use.

According to FIG. 3, conventionally, for displaying the current position, travel length, or other information of the linear motor 1 on a machine, it is necessary to output the analogical signal of the position probe 3 to an additional position display device 6 through a signal cable. The position display device 6 then converts the received analogical signal to visually readable information about the position and travel length that to be displayed through a display unit 7.

Furthermore, since the position probe 3 and the magnetic scale 2 are typically arranged with a preset distance therebetween so as to prevent the both from impacting or rubbing against each other due to insufficient distance or failure of detecting the magnetic variation of magnetic variation, an LED 8 is provided for informing an operator whether the preset distance is correctly kept.

The aforementioned functions each require an independent mechanical assembly to realize. Thus, in installation of the position probe 3, many signal cables have to be individually set. Besides, the manufacture, storage, and inventory of the numerous parts are cost-consuming, time-consuming and labor-consuming. Therefore, it would be desired to develop a device that provides all the foregoing functions independently.

### SUMMARY OF THE INVENTION

The primary objective of the present invention is to provide a position display device providing a digital displacement signal, wherein the position display device converts an analogical displacement signal received thereby into the readout visually readable to an operator and converts the analogical displacement signal into the digital displacement signal that is later output for a motor controller to use.

To achieve this and other objectives of the present invention, the position display device comprises: an analogical signal input port, electrically connected to a position probe of a magnetic scale for receiving an analogical displacement signal output by the position probe; a position display module, serving to convert the analogical displacement signal received by the analogical signal input port into a readout visually readable to an operator and display the readout through a display unit; an analog/digital conversion module, serving to convert the analogical displacement signal received by the analogical signal input port into the digital displacement signal; and a digital signal output port, serving to output the digital displacement signal converted by the analog/digital conversion module.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawing, wherein:

FIG. 1 is a schematic drawing of a conventional assembly of a linear motor and a magnetic scale;

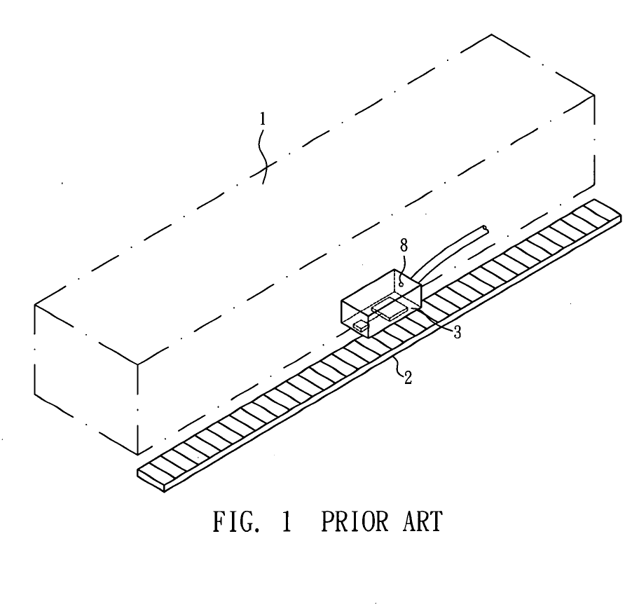

FIG. 2 is a schematic drawing illustrating signal feedback of the conventional linear motor;

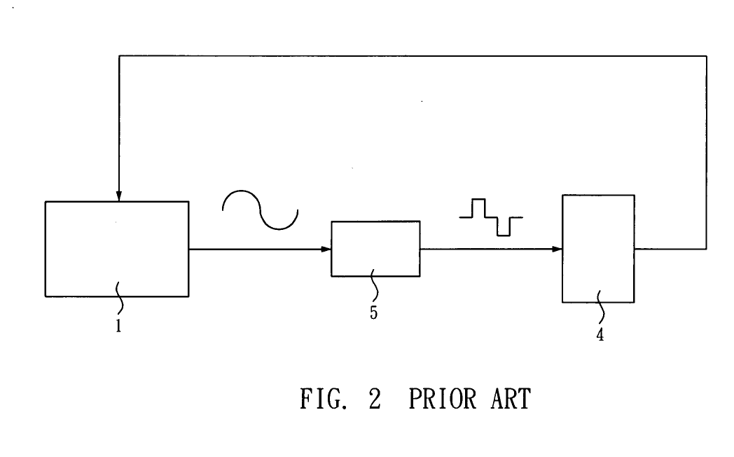

FIG. 3 is a schematic drawing showing a position display device assembled to the conventional linear motor;

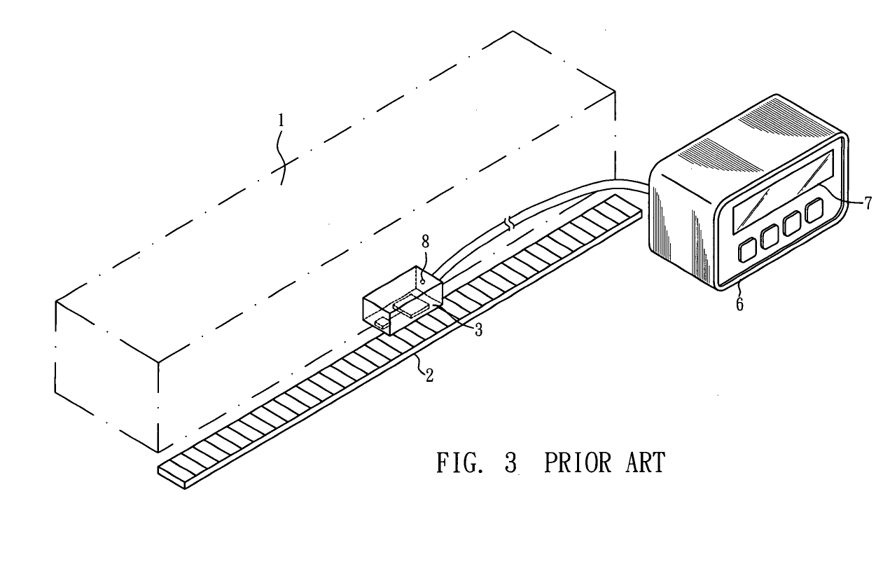

FIG. 4 is a front view of a position display device of the present invention;

FIG. 5 is a schematic drawing showing operation of the position display device of the present invention; and

FIG. 6 is a schematic drawing illustrating installation of a position probe according to the present invention.

### DETAILED DESCRIPTION OF THE PREFERRED EMBODIMENT

While a preferred embodiment provided hereinafter for illustrating the concept of the present invention as described above, it is to be understood that the components of the embodiment shown in the accompanying drawings are depicted for the sake of easy explanation and need not to be made in scale.

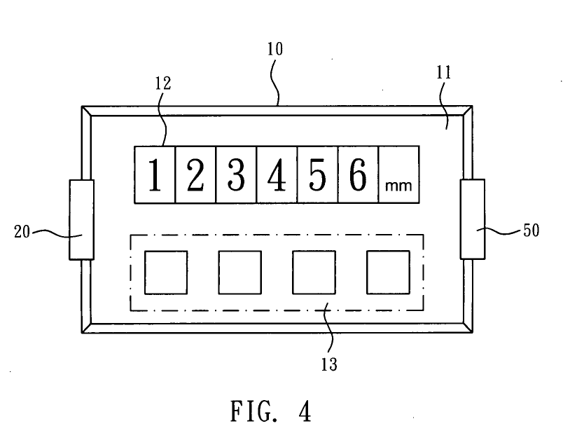

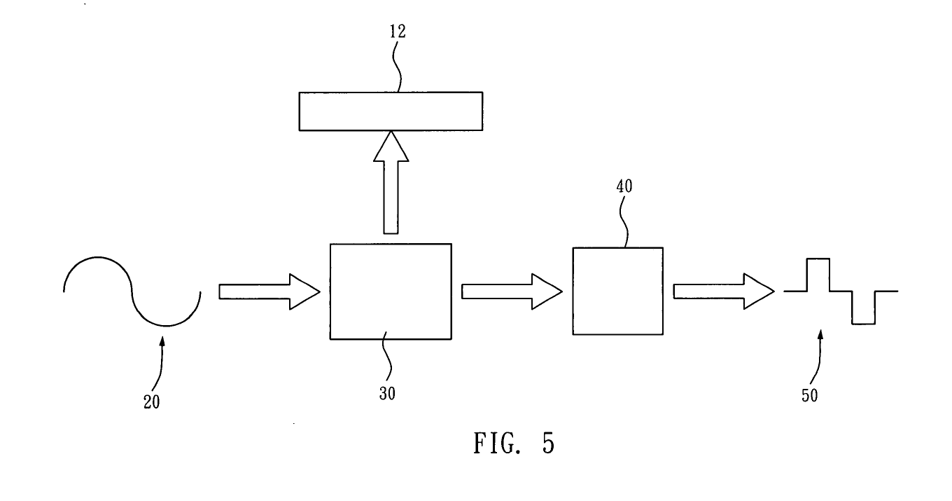

As shown in FIGS. 4 and 5, a position display device providing a digital displacement signal of the present invention includes a body 10, an analogical signal input port 20, a position display module 30, an analog/digital conversion module 40, and a digital signal output port 50.

The body 10 is structurally a hollow container for accommodating mechanical parts therein. A panel 11 is settled on a facade of the body 10 and has a thereon a display unit 12 as well as a plurality of operation buttons 13.

The analogical signal input port 20 is electrically connected to a position probe of a magnetic scale of a linear motor through a signal cable for receiving an analogical displacement signal output by the position probe.

The position display module 30 serves to convert the analogical displacement signal received by the analogical signal input port 20 into a readout relating to position or travel length of the linear motor visually readable to an operator and display the readout through the display unit 12.

The analog/digital conversion module 40 serves to convert the analogical displacement signal received by the analogical signal input port 20 into the digital displacement signal.

The digital signal output port 50 serves to output the digital displacement signal converted by the analog/digital conversion module 40.

By the above structure, the position display device is enabled to work as below.

Referring to FIG. 5, after the analogical signal input port 20 receives the analogical displacement signal from the position probe of the magnetic scale, the position display module 30 converts the analogical displacement signal received by the analogical signal input port 20 into the readout relating to position or travel length of the linear motor. The readout is visually readable to an operator. Then the position display module 30 displays the readout through the display unit 12 for the operator to read.

Additionally, the analog/digital conversion module 40 processes the analogical displacement signal with an analog/digital conversion procedure to convert the analogical displacement signal into the digital displacement signal. Afterward, the digital displacement signal is transmitted through the digital signal output port 50 to a connected motor controller, PLC, control computer or the like for providing position feedback of the linear motor.

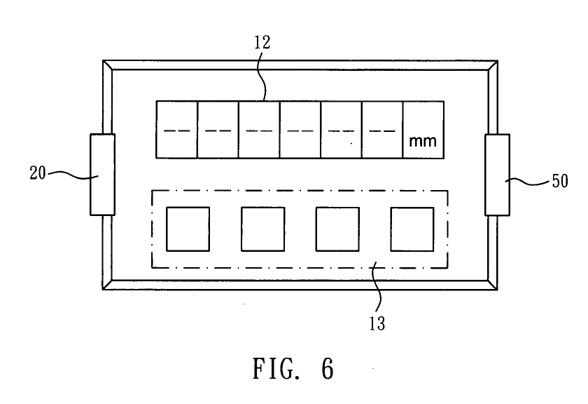

Furthermore, as shown in FIG. 6, the position display module 30 may further provide information through the display unit 12 to indicate whether the position probe of the magnetic scale is properly installed. For example, when the position probe is not properly installed, the position probe fails to detect the magnetic variation of the magnetic scale, so the analogical signal input port 20 receives no signal. At this time, the display unit 12 may inform the operator of the improper installation by providing an idle display or showing a phrase describing the improper installation. After the position probe is adjusted and properly arranged, the display unit 12 may turn to provide the position readout or a phrase describing the proper installation as a confirmation of correct installation of the position probe.

In the present invention, the single position display device provides functions of position display and digital signal readout. It not only facilitates reducing manufacturing costs by saving space and wiring work during installation, but also provides an instillation check function for simplifying the structure and components of the position probe, thus being more reliable and practicable.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A position display device providing a digital displacement signal, the position display device comprising:
an analogical signal input port, which is electrically connected to a position probe of a magnetic scale for receiving an analogical displacement signal output by the position probe;
a position display module, which serves to convert the analogical displacement signal received by the analogical signal input port into a readout visually readable to an operator and display the readout through a display unit;
an analog/digital conversion module, serving to convert the analogical displacement signal received by the analogical signal input port into the digital displacement signal; and
a digital signal output port, serving to output the digital displacement signal converted by the analog/digital conversion module.

2. The position display device of claim 1, wherein the position display module comprises a panel for a display unit to be installed thereon.

3. The position display device of claim 2, wherein the panel is provided with a plurality of operation buttons to be operated for switching functions.

4. The position display device of claim 1, wherein the position display module displays information relating to position and travel length through the display unit.

5. The position display device of claim 1, wherein the position display module displays information relating to correct installation of the position probe through the display unit.
